(19) United States
(12) Patent Application Publication
(10) Pub. No.: US 2001/0035650 A1
(43) Pub. Date: Nov. 1, 2001

(54) Umbilical hose joint

(76) Inventors: Svein Tangen, Oslo (NO); Bjorn Bjerke, Rolvsoy (NO); Jan-Erik Karlsen, Kolbotn (NO)

Correspondence Address: SUGHRUE, MION, ZINN, MACPEAK & SEAS, PLLC, 2100 PENNSYLVANIA AVENUE, N.W., WASHINGTON, DC, 20037-3213, US

(21) Appl. No.: 09/818,538

(22) Filed: Mar. 28, 2001

(30) Foreign Application Priority Data
Mar. 28, 2000 (NO) 2000 1606

(51) Int. Cl. B23P 11/00; B21D 39/00

(52) U.S. Cl. 285/371; 29/516; 285/256

(57) ABSTRACT

Umbilical hose joint for connecting the ends of two hoses (1, 2) to each other in order to establish a continuous hose having a substantially uniform diameter, said joint comprising an inner sleeve extending into the ends of the two hoses (1, 2), each hose being crimped to the sleeve by a hose fitting (6, 7), said inner sleeve (3) being made of a single piece.

The present invention is related to a hose joint for use especially during manufacturing of an umbilical hose for an offshore polymer hose for transportation of gas, oil and other fluids.

During manufacturing of umbilical hoses of the above-mentioned type, the hose experiences fractures and breakages. Due to the claims for tolerances and requirements for acceptance of the umbilical hose, such hoses cannot be used. It therefore is an object for the present invention to provide a method and a means for repair of such umbilical hoses according to a satisfactory standard, thereby avoiding scraping valuable umbilical hose lengths.

Joints in polymer hoses of the above type normally do not allow removal after completion of the joint, due to the methods used with pressure tools. It is essential that joints for this purpose should not increase the outer diameter of the hose.

Joints of hoses are well know from a number of publications, such as EP-0 339 248, EP-0 539 844, EP-0 762 034, U.S. Pat. Nos. 4,114,930, 4,277,091, 4,321,743, 4,482,174, 4,598,938, 4,726,612, 5,228,721 and 5,387,016. None of these publications, however, discloses hose joints having substantially the same outer diameter as the rest of the hose as claimed for hoses for the present use.

Document WO 88/09898 discloses a connection for tubes made of composite materials. According to this document, in order to connect the ends of two tubes to each other, two inner sleeves are used, each being inserted into the end of one of the tubes, and a hot-shrink fitted outer sleeve crimps around the ends of the hoses in order to ensure a permanent connection.

The connection according to this document uses sleeves that have a conical shape and the interior of the tubes to be connected needs to be adapted to such a shape. This renders the connection complex and not easily reproducible.

In addition, the connection according to this document uses a great number of components, which makes it quite expensive and not very reliable.

More precisely, by using two inner sleeves, it is necessary that the joint has a long length, so as to leave the required free length of the inner sleeves in order to join them together, e.g. by welding. Such a welding operation, in addition, is complex and lengthy.

The present invention is therefore aimed at designing a joint for connecting two hoses together which simpler, quicker and more reliable than the one of the prior art.

The above problems are solved with the hose joint according to the present invention, as defined by the features stated in the claims.

The invention therefore provides a method for connecting the ends of two hoses to each other in order to establish a continuous hose having substantially uniform diameter, comprising the steps of:

guiding an inner sleeve into the ends of the two hoses, and

crimping a hose fitting around the ends of the hoses thereby to ensure permanent fit between the fitting, the hoses and the sleeves,

characterized in that said inner sleeve is made of a single piece.

The method of the invention, which uses an inner sleeve made of a single piece, is therefore much simpler, quicker and more reliable than the prior art method. The use of a one-piece inner sleeve also allows to shorten the length of the joint, because it is not necessary anymore to have a long protruding length out of the end of the two hoses to be joined as no welding of inner sleeves together is needed.

The invention also covers an umbilical hose joint for connecting the ends of two hoses to each other in order to establish a continuous hose having a substantially uniform diameter, said joint comprising an inner sleeve extending into the ends of the two hoses, each hose being crimped to the sleeve by a hose fitting, characterized in that said inner sleeve is made of a single piece.

The invention will be better understood from the following embodiment given by way of example and illustrated in the drawing.

In the following drawing:

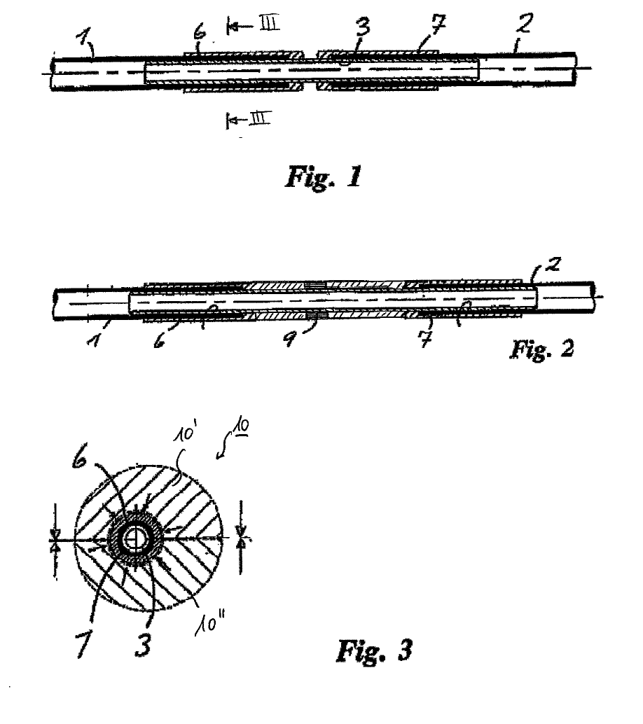

FIG. 1 is a longitudinal section through a joint according to the invention,

FIG. 2 shows the joint of FIG. 1 with a winding for diameter matching

FIG. 3 is a view cut along line III-III of FIG. 1 and which schematically shows the method for crimping the joint parts.

FIG. 1 discloses two hoses or hose ends 1 and 2 into each of which a one-piece inner sleeve 3 is inserted. The inner sleeve 3 extends into the ends of both hoses 1 and 2, and is made e.g. of Inconel 625 (known under the standardized reference AMS 5401/ASME SB443) or SuperDuplex (known under the standardized reference UNS S32750) material. The inner sleeve 3 has a substantially cylindrical shape adapted to be fitted in the ends of hoses 1, 2.

Each hose end is crimped to the sleeve 3 by an outer hose fitting 6 and 7 made e.g. of Inconel 625.

As shown in FIG. 2, a wrapping material 9 is wound around the portion of the sleeve 3 left between the ends of the two hoses 1 and 2, and is built up to have an outer diameter corresponding with the outer diameter of the hose fittings 6 and 7. Therefore, the open length of the sleeve 3 left between the ends of the two hoses 1, 2 is covered and filled up by winding several layers of a suitable material to reach substantially the outer diameter of the hose 1, 2.

As shown in FIG. 3, a splitted hydraulic crimping tool 10 made of two parts 10′ and 10″ is used to provide the necessary crimping forces on the hose fittings 6 and 7. In the embodiment of FIG. 3, a special splitted hydraulic tool 10 is needed, which is able to grip the hose fittings radially with two jaws and thereafter crimp the fittings 6, 7.

As can be seen from the drawing, the outer diameter of the joint according to the invention only has a slightly larger diameter than the hose itself. Furthermore the jointing method does not require much overlength of the hose, which after joining has to be laid into the umbilical hose as part of the umbilical hose crosssection.

According to the invention, the two hose fittings 6 and 7 can be replaced by a single hose fitting (not shown) covering the ends of the two hoses 1 and 2. In such a case, when a wrapping is added to fill up the space between the ends of the two hoses, it is afterwards covered by the single hose fitting.

Besides, the crimping tool may be made of more than two parts without departing from the scope of the present invention.

Similarly, the tool may be able to grip the fittings with more than two jaws.

1. Method for connecting the ends of two hoses to each other in order to establish a continuous hose having a substantially uniform diameter, comprising the steps of:
guiding an inner sleeve into the ends of the two hoses (1,2), and
crimping a hose fitting (6, 7) around the ends of the hoses thereby to ensure permanent fit between the fitting (6, 7), the hoses (1, 2) and the sleeve (3),
characterized in that said inner sleeve is made of a single piece.

2. Method according to claim 1, characterized in that it further comprises the step of covering and filling up the open length of sleeve (3) left between the ends of the two hoses (1, 2) by winding several layers of a suitable material to reach substantially the outer diameter of the hose (1, 2).

3. Method according to anyone of claims 1 or 2 characterized in that one hose fitting (6, 7) is used for each hose (1, 2).

4. Method according to anyone of claims 1 or 2 characterized in that a single hose fitting is used for both hoses (1, 2).

5. Method according to anyone of claims 1 to 4 characterized in that the crimping of the hose fitting (6, 7) is made by use of a splitted hydraulic crimping tool (10).

6. Umbilical hose joint for connecting the ends of two hoses (1, 2) to each other in order to establish a continuous hose having a substantially uniform diameter, said joint comprising an inner sleeve extending into the ends of the two hoses (1, 2), each hose being crimped to the sleeve by a hose fitting (6, 7), characterized in that said inner sleeve (3) is made of a single piece.

7. Umbilical hose joint according to claim 6, characterized in that the sleeve portion left between the ends of the two hoses (1, 2) is filled up to the diameter of the hose by winding.

8. Umbilical hose joint according to anyone of claims 6 or 7, characterized in that it comprises one hose fitting (6, 7) for each hose (1, 2).

9. Umbilical hose joint according to anyone of claims 6 or 7, characterized in that it comprises a single hose fitting for both hoses (1, 2).
